(19) United States
(12) Patent Application Publication
(10) Pub. No.: US 2006/0172058 A1
(43) Pub. Date: Aug. 3, 2006

(54) Concentrated-protein food product and process

(75) Inventor: Ronald Achs, Sun Valley, ID (US)

Correspondence Address: BLACK LOWE & GRAHAM, PLLC, 701 FIFTH AVENUE, SUITE 4800, SEATTLE, WA, 98104, US

(73) Assignee: Dominion Nutrition, Inc.

(21) Appl. No.: 11/395,941

(22) Filed: Mar. 31, 2006

Related U.S. Application Data
(63) Continuation-in-part of application No. 11/096,812, filed on Mar. 31, 2005.
Application No. 11/096,812 is a continuation-in-part of application No. 10/940,560, filed on Sep. 13, 2004.
(60) Provisional application No. 60/546,079, filed on Feb. 18, 2004.
(60) Provisional application No. 60/546,544, filed on Feb. 20, 2004.

(51) Int. Cl. A23J 1/04

(52) U.S. Cl. 426/657

(57) ABSTRACT

A system, processes, and milk-based food products made from the system and processes, in which cream is separated from milk to produce an ultra-low fat milk product. The milk product is microfiltered to produce a retentate that is ready to drink and is high in protein and has no or substantially no fat. The permeate from the microfiltration process is ultrafiltered to produce a retentate that is high in protein with few other solids. The permeate of the ultrafiltration step, or other milk salt containing fluid may be used to perform diafiltration on the retentate of the microfiltration process. The permeate may also be used to provide protein fortification to other food and beverage products, and is especially useful in its liquid form for such fortification.

### PRIORITY CLAIM

This application is a Continuation-In-Part of U.S. patent application Ser. No. 11/096,812, filed Mar. 31, 2005. Ser. No. 11/096,812 is a Continuation-In-Part of U.S. application Ser. No. 10/940,560, filed Feb. 18, 2004. Ser. No. 10/940,560 claims the benefit of U.S. Provisional Applications Ser. No. 60/546,079, filed Feb. 18, 2004, and Ser. No. 60/546,544, filed Feb. 20, 2004, which are hereby incorporated by reference.

### FIELD OF THE INVENTION

This invention relates generally to methods and systems for producing milk-based food and beverages, and the food and beverage compositions produced using those systems and methods.

### BACKGROUND OF THE INVENTION

Prior art methods for producing protein fortified liquid products use two or more facilities prior to end product distribution. As illustrated in FIG. 1 the primary milk processing facility initiates the milk protein rendering process; the secondary or further processing segment formulates the end products; and a third facility typically coordinates product distribution.

Presently, Concentrated Milk Proteins, or CMPs, are processed into powder to accommodate efficient delivery of the derived proteins to other facilities. The CMPs are then reconstituted via “Sodium Caseinate” into a liquid form for further processing into a desired end-product. Rendering the CMPs into a powder includes evaporating the moist emulsifier-mated protein product by employing heat and chemical treatments. Throughout this process of drying, the emulsifier-mated protein molecules are damaged, degrading the proteins overall quality and physical structure. After drying, the powdered emulsifier-mated protein must be packaged for distribution.

Furthermore, because current systems may require two or three facilities and one or more of those facilities may not be USDA approved, the ability to produce USDA approved products is lost. With the use of two or more facilities, capital investment for the processing and manufacturing plants is also much higher and operating expenses increase proportionately.

There is therefore a need for a system that can provide one or more advantages in eliminating the need for multiple facilities, consolidating processing equipment, increasing opportunities for USDA approval, reducing risk of contamination, and eliminating the need for drying and rendering CMPs into powdered form and then emulsifying it to add it to the consumable products.

The dairy industry has long followed the above process when seeking to produce foods fortified with milk solids. At the same time, it has used various forms of filtration in order to separate cream and to produce standard beverages such as low fat milk or skim milk. In the course of separating cream from whole milk, milk having varying levels of fat and other components is produced. Depending on the process employed, the milk may be, for example, two percent or skim milk. In some cases, the production of cream having particular characteristics may produce a retentate that does not meet the definition of skim milk or other well-defined milk products. If so, the retentate might be discarded as waste or dried as described above in order to obtain certain milk solids. There is a further need, then, for a system that enables the suitable use of such retentates in direct consumable beverages or in the direct production of other food products.

### SUMMARY OF THE INVENTION

Preferred embodiments of the present invention include systems, processes, and milk-based food and beverage products made from the systems and processes, in which cream is separated from milk to produce an ultra-low fat milk product. Ideally, the cream is separated such that about 44 percent of the milk fat has been removed from the original whole milk.

The milk product with the cream removed is microfiltered to produce a retentate that is ready to drink and is high in protein and has no or substantially no fat. The milk product has a mouth feel similar to other whole or full-fat milk, even though it has essentially no fat.

The permeate from the microfiltration process is ultrafiltered to produce another retentate stream that isolates serum proteins. This retentate may be used to provide protein fortification to other food and beverage products, and is especially useful in its liquid form for such fortification.

### BRIEF DESCRIPTION OF THE DRAWINGS

The preferred and alternative embodiments of the present invention are described in detail below with reference to the following drawings.

FIG. 1 depicts a prior art method for producing fortified liquid dairy products;

FIG. 2 depicts a general flow diagram for one embodiment of the present invention;

FIG. 3A is a table indicating a preferred component table for a milk-based liquid after pasteurization and cream separation;

FIG. 3B is a table indicating a preferred component table for a milk-based liquid after microfiltration of the product indicated in FIG. 3A;

FIG. 3C is a table indicating a preferred component table for a milk-based liquid beverage;

FIG. 3D is a table indicating a preferred component table for a milk-based liquid beverage;

FIG. 3E is a table indicating a preferred component table for a milk-based liquid beverage;

FIG. 4 is a schematic diagram for a preferred system for producing milk-based products;

FIG. 5A is a diagram showing component tables corresponding to some of the processes within the system of FIG. 4;

FIG. 5B is a diagram showing component tables corresponding to some of the processes within the system of FIG. 4;

FIG. 5C is a diagram showing component tables corresponding to some of the processes within the system of FIG. 4

FIG. 6 is a flow diagram illustrating a preferred method of producing milk-based products;

FIG. 7 is a flow diagram illustrating a preferred method of producing milk-based products;

FIG. 8 is a flow diagram illustrating a preferred method of producing milk-based products;

FIGS. 9A and B illustrate a diagram showing component tables for the products of processes performed in accordance with an embodiment of the present invention;

FIG. 10 is a flow diagram illustrating a method for producing milk-based products;

FIG. 11 is a flow diagram illustrating a method for producing milk-based products having a microbial microfiltering step;

FIG. 12 is a flow diagram illustrating a method for producing milk-based products using diafiltration with milk ultrafiltrate;

FIG. 13 is a flow diagram illustrating a method for producing milk-based products using a milk-salt solution; and

FIG. 14 is a flow diagram illustrating a method for producing milk-based products using a lactose-salt solution.

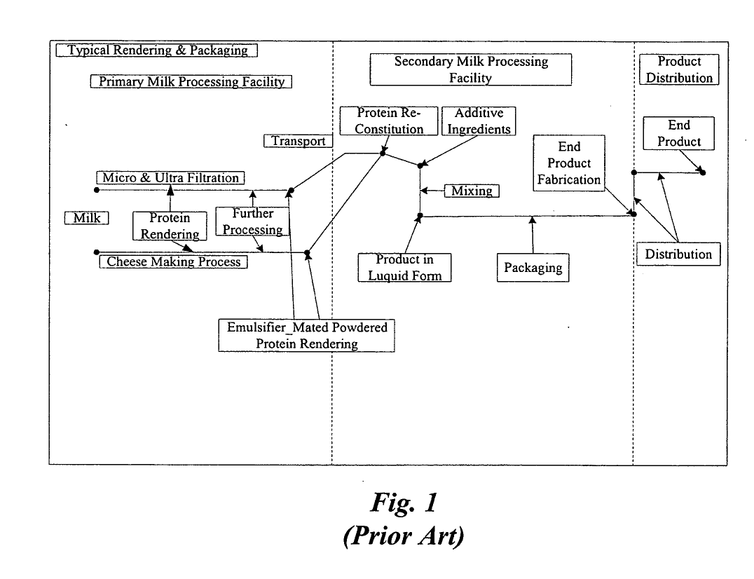

### DETAILED DESCRIPTION OF THE PREFERRED EMBODIMENT

The preferred embodiment of the present invention provides for isolating, concentrating, pasteurizing, processing, and packaging component naturally occurring milk proteins in such a manner that direct salable products and products that can be used as ingredients for direct salable goods are produced. Among the benefits of certain embodiments of the system is to eliminate the risk of contamination to the Concentrated Milk Proteins (“CMP”) often associated with distribution oriented packaging. Since all CMP rendering, further processing and packaging is located in one facility, the plant using the invention can also operate much more efficiently and can petition to have its process and products manufactured in a “USDA Approved” facility—an option that may not be exercised by prior methods, which use multiple facilities for different segments of end product production.

Since the CMPs in the preferred embodiment are directly routed in liquid form, the need to further process the CMPs by employing damaging emulsifiers (Sodium or Calcium) mated to the milk protein molecules is eliminated. The emulsifiers are needed to reconstitute powdered protein into a useable liquid form for further processing—a step that is required in the prior methods—and the mating of emulsifiers to the protein molecules degrades the purity of the milk proteins. After the process of reconstituting the CMPs, the milk protein molecule is no longer considered a pure milk protein, and loses much of its functionality. As an example, Casein that has been mated to an emulsifier such as Sodium is known as “Sodium Caseinate” which is no-longer considered a pure milk derived protein. Since the CMPs produced in the preferred embodiment are derived in a liquid form and are maintained in that form throughout further processing, no mating of an emulsifier is needed thereby creating an all natural protein in the form of casein and whey protein concentrates (“WPC”) that can be further processed into various desired products.

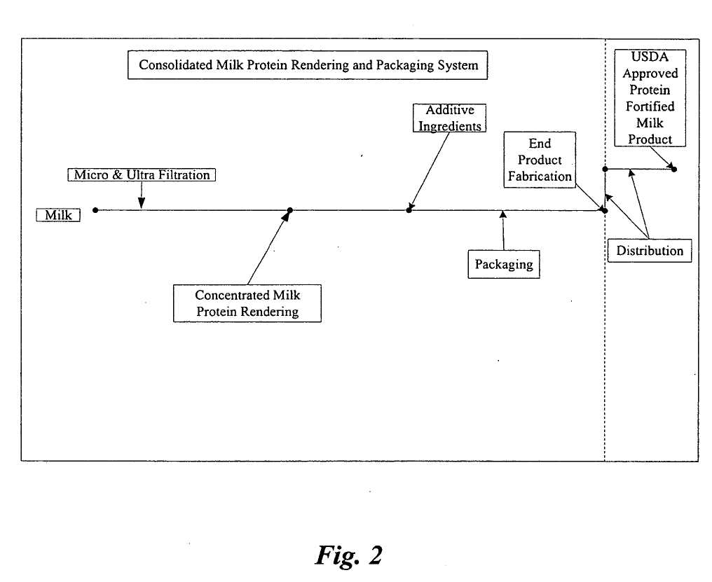

One general overview of the system is shown in FIG. 2. The consolidated system begins initially by filtering milk in one or more steps, preferably including a microfiltration step and an ultrafiltration step. One output from the filtration is the “retentate,” as discussed further below. The retentate may take a variety of forms, but preferably comprises a particular “mass balance” that is high in protein and low in fat. After production of the retentate, one or more ingredients is added in order to provide flavoring, vitamins, or other aspects. The retentate may alternatively be used in the production of ice cream, cheese, or other food products, as further described below. The resulting consumable is then packaged and distributed for ultimate sale.

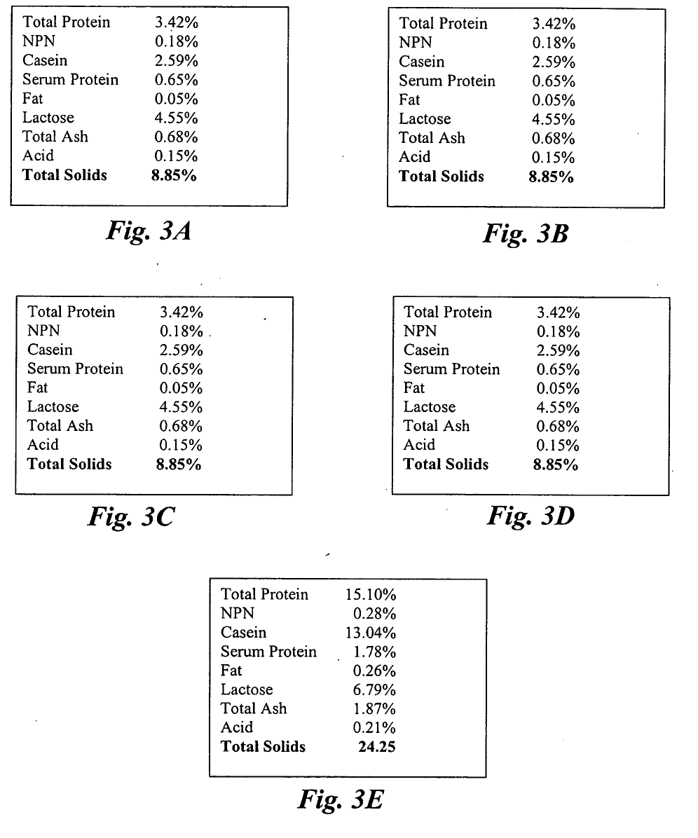

The initial process begins with raw milk that is preferably unprocessed. The milk then is processed by separating the cream and pasteurizing the milk. Equipment for cream separation and pasteurization is readily available. The pasteurization and separation step is performed on whole milk in order to produce a milk-based liquid having the characteristics shown in FIG. 3A.

The milk configuration above is then further processed in a microfiltration step. This microfiltration step reduces the amount of bacteria that has formed, thereby not requiring excessive heating during UHT pasteurization. The filtration equipment and suitable filtration membranes for producing the desired characteristics are commercially available. The particular filtration membrane and processing is chosen to produce the retentate output configuration for the CMP base, as shown in FIG. 3B.

The CMP base is then diluted with water sourced from the original permeate stream which is polished via reverse-osmosis to either of the two output configurations shown in FIG. 3C or 3D (among others), one considered preferable for the subsequent production of diet shakes, and one considered preferable for a concentrated protein milk beverage.

After dilution, the liquid is filtered again as described in the microfiltration step in order to concentrate the retentate even further to achieve the preferred output configuration of FIG. 3E. This microfiltration step employs a microfiltration membranes that have a different pore size than the microfiltration membranes of the previous microfiltration step.

As is indicated from the mass balance, the resulting liquid is extremely high in protein while very low in fat (or non-fat, pursuant to USDA and/or FDA known standards).

The above filtered retentate configurations (that is, after either one or two filtration steps) are next mixed with natural or artificial flavors to achieve any one of the following flavors: Chocolate, dark chocolate, vanilla, strawberry, root beer float, banana split, caramel, blueberry, grape, chocolate/vanilla swirl, butter pecan, cookie dough, mocha java, coffee, peach, cheese cake, raspberry, blackberry and peanut butter.

In addition, or in the alternative, the retentate configurations above are blended with natural or artificial coloring to achieve any of the following colors: Chocolate brown, strawberry red, raspberry red, root beer brown, peach, purple, blue, green, banana yellow, blackberry, tan, coffee, and peanut butter.

In addition, or in the alternative, the process fortifies one or more of the retentate configurations shown above with vitamins, fiber, or minerals, such as the USDA recommended daily allowance (100% for a 2,500 calorie diet) of 11 vitamins and minerals per 8 ounce serving pursuant to the following schedule:

A B Vitamin (Niacinamide), Vitamin E (Tocopheryl Acetate), Vitamin C (Sodium Ascorbate), Trisodium Phosphate, A B Vitamin (Calcium Pantothenate), Vitamin B₆ (Pyridoxine Hydrochloride), Vitamin B₂ (Riboflavin), Vitamin B₁ (Thiamin Mononitrate), A B Vitamin (Folic Acid), Vitamin A (Palmitate), Vitamin B₁₂, Vitamin D, Zinc and Iron.

In addition, or in the alternative, the process blends the retentate configuration shown in either Step #3 or Step #4 with Sucralose (up to 15 grams per 8 ounce serving) or any other natural or artificial sweetener.

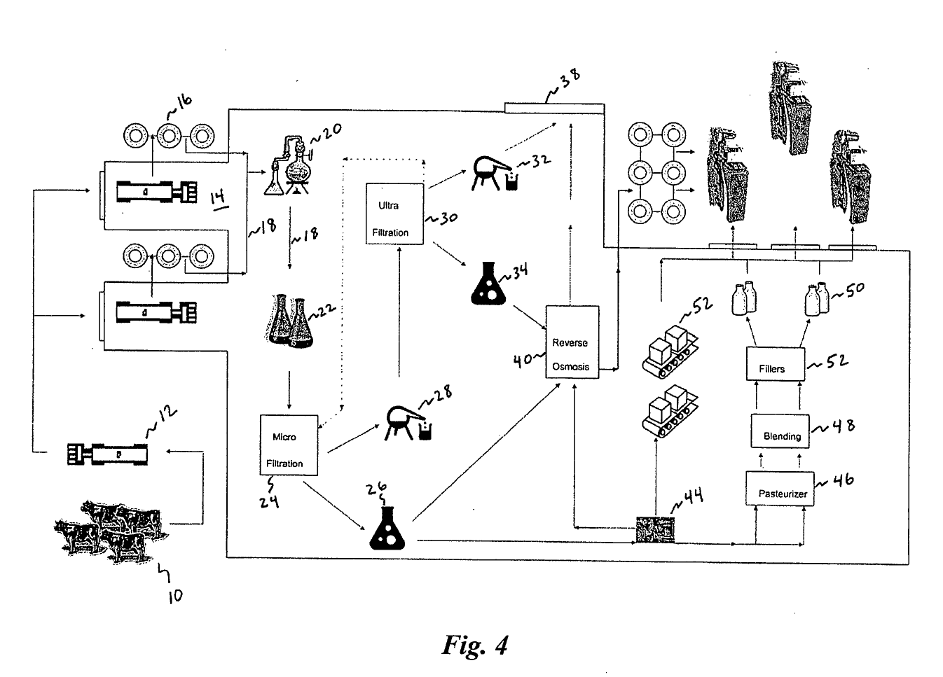

A further overview of the preferred embodiment of the invention is illustrated in FIG. 4. In this form, as with the foregoing preferred embodiment, the system is shown as a dairy processing facility in which there is a continuous flow of the process from milking dairy cows through the distribution of final consumable products.

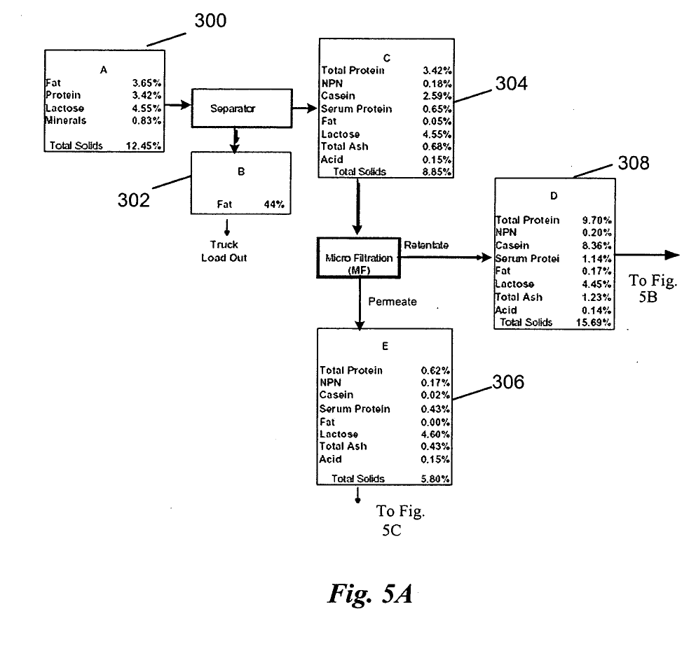

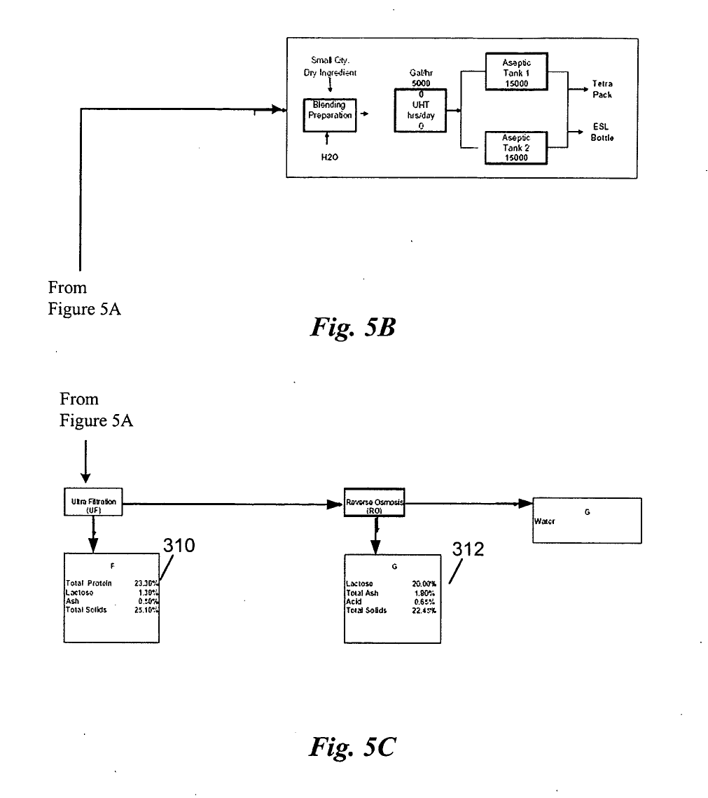

Initially, dairy cows 10 at any location provide milk that is transported via tank trucks 12 to receiving bays 14 at one end of the facility. Any number of trucks and receiving bays may be incorporated for this purpose. Likewise, depending on the location of the dairy farm, the milk may be delivered to the facility from the milking station via pipes or similar means. The composition of the milk as it is processed in the facility of FIG. 4 is shown in FIGS. 5A-C. The milk at the time it is received and stored within the silos is indicated in FIG. 5A at block 300, listing exemplary relative concentrations of fat, protein, lactose, and minerals. It should be understood that the values in block A may vary depending on a variety of factors related to the raising of cattle, the production of milk at the dairy, season or weather.

Once at the facility, the trucks 14 unload the milk into one or more receiving silos 16. Any number of silos may be used, depending on the size of the facility and the quantity of milk processed. Likewise, while silos are used in the preferred embodiment, smaller tanks or other milk receiving or holding devices may also be used.

The milk within the silos 16 is conveyed via pipes 18 to a pasteurizer 20, which pasteurizes the raw milk. In a preferred form, a standard heating process is used for pasteurization. Any other method of pasteurization may be used, consistent with the invention. For that matter, the pasteurization step is not essential, but may be a desired or required step in standard dairy product processing. As yet another alternative, the milk may be pasteurized at the dairy farm or another location prior to delivery to the facility and receipt within the silos 16. Following pasteurization, the milk will still contain the relative concentrations indicated in block 300.

Following pasteurization, the milk is delivered, through additional pipes 18 to a cream separator 22 where the cream is removed from the whole milk, with the remaining dairy product homogenized (optionally) after the separation. It should be noted that, although not shown in most cases in FIG. 4, any number of pumps and valves are incorporated within the system as necessary to control the flow of milk from one processing station to another. In the preferred form, the cream separator comprises a centrifuge.

One of the key aspects of the preferred form of the invention is the separation of cream at a very high level. Preferably, the fat content of the separated cream will exceed 42 percent, and ideally it will be at a level of 44 percent or more, as indicated in block 302 in FIG. 5. The separation of cream at such a high concentration of fat provides for cream that is particularly well-suited for use in butter, premium ice creams, and also produces a remaining dairy product having unique qualities. The cream is then packaged, pumped into a tank for delivery to another location, or placed in a storage tank for subsequent use in making ice cream or other products within the same facility. The remaining processing steps depicted in FIG. 4 relate to the processing of the portion of the whole milk that remains after the cream has been separated.

The product remaining after typical separation of cream from whole milk is classified as skim milk. In the preferred form as depicted in FIG. 5A, however, the amount of cream that has been removed from the milk exceeds the amount that is removed even to produce skim milk (according to known standards of identity for skim milk). Accordingly, the remaining dairy product after separation does not qualify as skim milk, is not marketable as such, and might well be discarded because it has no readily appreciated uses. The composition of the remaining product is indicated at block 304. As shown, the preferred fat concentration is a very low 0.05 percent while the protein concentration remains high.

The remaining milk product is then passed through a microfiltration membrane 24, which produces a first permeate 28 and a first retentate 26. The permeate following microfiltration has a preferred composition as indicated in block 306, while the retentate has a preferred composition as indicated in block 308. The retentate is high in protein and casein while relatively low in concentration of fat and other components. The permeate, however, is also relatively high in total protein and lactose concentration while containing virtually no fat.

The permeate 28 is then passed through an ultrafiltration membrane 30, which produces a second permeate 32 and a second retentate 34. The second permeate 32 is comprised primarily of water and lactose, as indicated in block 310. For that reason, a portion of the permeate purified using reverse osmosis or diafiltration, then fed back via pipes 36 and reused to aid in the microfiltration process at block 24. Permeates of diafiltration processes contain salts and certain other microcomponents, The remaining permeate 32 is transferred to a wastewater pretreatment block 38, where reverse osmosis, addition of enzymes, or other processes are used to remove lactose and much of the remaining other compounds (see block 312, consisting primarily of lactose) so that the water can be disposed of properly. The lactose 312 can alternatively be dried and bagged for subsequent sale as a separate product.

The second retentate 34 (ultrafiltration) isolates the serum proteins found only in this permeate and contains virtually no fat. It is also very low in lactose and other components, as indicated in block 308. The second retentate is optionally passed to a reverse osmosis condenser 40 to further concentrate the composition, and then transferred to storage tanks or silos 42 for subsequent distribution or incorporation into other products.

Because the second retentate 34 is very high in serum protein but contains no fat and very few other compounds, it is essentially a protein-fortified water. It may therefore be readily used to add protein in a liquid form to other beverages (for example, sodas or sport drinks) or other food products. As shown in FIG. 4, the second retentate is preferably housed for shipment to other beverage or food processing facilities where it is incorporated into such products. Alternatively, the same facility may include additional food or beverage processing systems, drawing directly from the tanks or silos 42 to use the second retentate in any amount as desired.

One advantage of the second retentate is that it is readily useful as a concentrated protein in liquid form. Unlike prior art processes for producing dairy proteins, it is not dried using heat or other such systems that denature the protein. Rather, it is produced in a system that maintains the protein at all times in liquid form, making it readily useful without drying and subsequent rehydration prior to use.

The first rententate 26 may also be used as-is, or can be delivered to a reverse osmosis condensing station 40 for further concentration. As with the second retentate 34, concentrating the first permeate is a useful step in the event it is to be shipped via tanker truck in large volumes to another facility for use in additional products. Thus, after reverse osmosis, the first permeate is transferred to storage silos 42 to await later shipment.

Within the facility, however, the first rententate 26 may be packaged in a variety of forms. The composition of the first rententate 26, as shown at block 308, is such that it is high in protein, low in fat, but also includes lactose and certain other milk compounds. The composition of the first rententate 26 is such that it has a similar “mouth feel,” taste, and color as typical milk, but with very high protein and virtually no fat. Preferably, the composition is greater than eight percent total protein, seven percent casein, and less than 0.3 percent fat. In one preferred embodiment, as shown at block 308, the composition is 9.7 percent total protein, 8.36 percent casein, and 0.17 percent fat. The 9.70 percent protein content of the retentate 26 about three times (2.84) that of the 3.42 percent protein content of the original milk. Accordingly, the first retentate can be packaged in a variety of ready to drink containers, bag-in-box fillers, or other such packages for a dairy beverage that is ready to drink. A directional valve 44 is used to control the flow of the first rententate 26 to the desired processing and packaging route.

As desired, or as necessary, the first rententate 26 may be pasteurized a second time at a pasteurizer 46. The first rententate 26 may also be blended with other liquid or dry ingredients such as flavorings, as described above, at a blending and processing station 48. Finally, the product is packaged using beverage fillers 52 and passed to shipping bays for ultimate distribution to consumers or retailers.

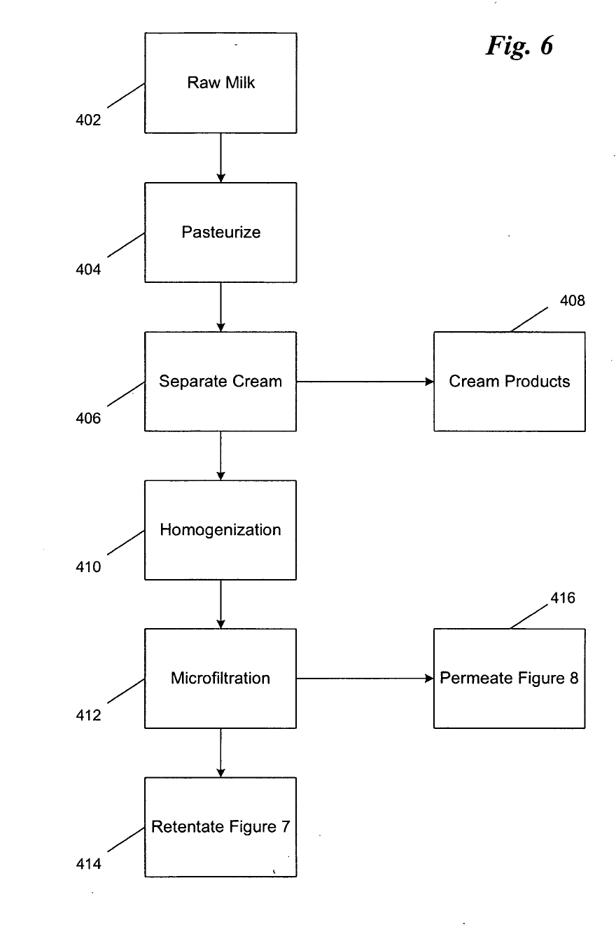

A flow diagram for producing milk-based liquids, beverages, and other products using the system described above is provided in FIG. 6. At a first block 402, raw milk is provided, preferably trucked in from nearby dairies but alternatively obtained from a dairy associated with the processing plant.

The raw milk is pasteurized 404 and then delivered to a centrifuge for separation of the cream 406. In accordance with most preferred embodiments of the invention, the cream separation step removes the cream such that the cream preferably comprises at least 42 percent fat, and ideally greater than 44 percent fat. The cream is then used directly as cream or alternatively to produce ice cream or other cream products 408.

The remaining milk-based liquid after the cream has been removed is very low in fat and is further processed to produce other preferred milk-based products. The milk, after cream removal, is homogenized 410 (optionally) and then microfiltered 412. The microfiltration produces a first retentate 414 and a first permeate 416.

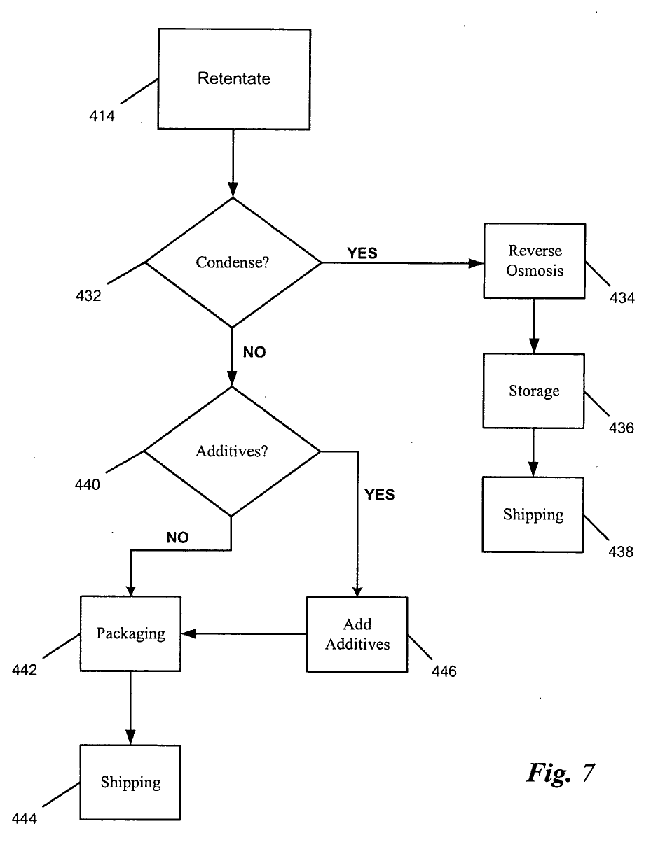

After production of the first retentate 414 (see FIG. 7), the process proceeds to a decision block 432 for optional condensation of the retentate. If it is desired to further condense the retentate, the process proceeds to block 434 where the liquid is condensed using reverse osmosis. After it is concentrated to the desired level, the liquid is stored 436 (if desired) and subsequently shipped 438. The storage step may be omitted and, instead, the liquid may be shipped without an intermediate storage.

If the product is not concentrated, it is ready for consumption as a milk-based beverage that, as described above, is very high in protein, has virtually no fat, and has a mouth feel that is similar to whole milk that includes a much higher level of fat. The product produced at this step in the process preferably includes greater than 9 percent total protein and greater than 7 or 8 percent casein. As compared to raw milk, there is more than double the amount of protein with substantially no fat.

The ready-to drink product may be enhanced with additives, as desired at a decision block 440. Additives may include, for example, flavorings, vitamins, or other ingredients, and are added at block 446. The blended beverage, or unmodified retentate, are packaged at block 442. The packaging may be in a variety of forms, such as ready to drink containers, gallon or similar containers, or bag-in-box fillers. After packaging, the products are ready for shipment 444 to wholesalers, retailers, or consumers.

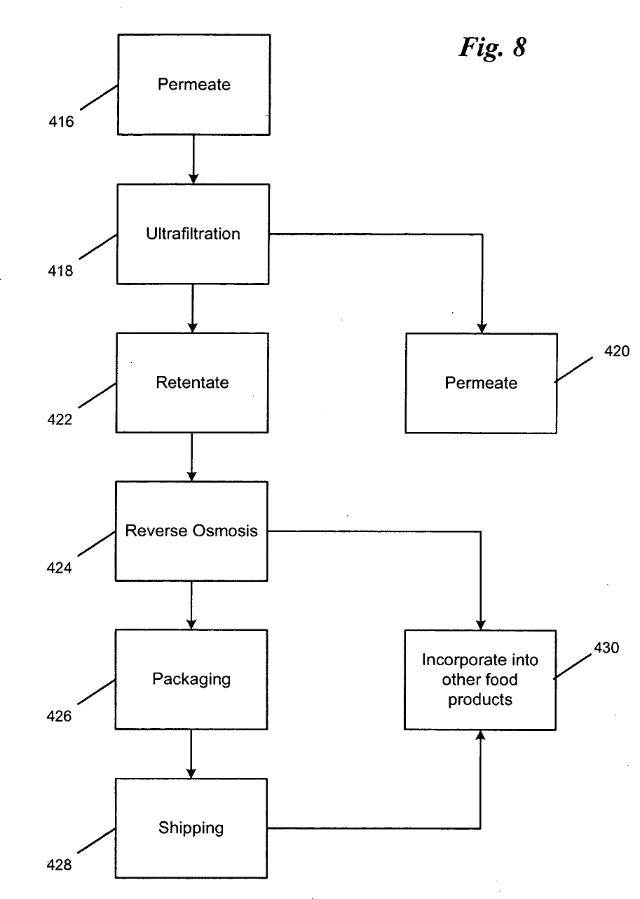

The first permeate (block 416 in FIGS. 6 and 8) is also further processed for subsequent use in a variety of products. At block 418, the first permeate undergoes ultrafiltration, which produces a second permeate 420 and a second retentate 422. The second permeate primarily includes lactose and water, and undergoes optional diafiltration for further use in the microfiltration step above to isolate additional milk solids. The remaining second permeate is processed to remove the lactose and any other elements for eventual disposal as wastewater. Optionally, the lactose may be removed and dried for use in other products.

The second retentate at 422 is then concentrated (if desired) in a reverse osmosis step 424. The concentrated second retentate is packaged 426 or stored for subsequent shipment 428. Following shipment (or optionally at the same facility), the second retentate (ultrafiltration which isolates the serum proteins) is added to other food or beverage products as a means for protein fortification for such products. The composition of the second retentate (see 308 in FIG. 5) is such that it is very high in protein but very low in other components. In the preferred form, the second retentate contains essentially no fat, about one third the original lactose of raw milk, and more than six times the amount of protein as a percentage of the total solids. The high protein and very low level of other ingredients, particularly fat, makes the second permeate especially useful for protein fortification.

In addition, the second permeate is preferably used in its liquid state, without drying the protein and rehydrating it for later use. As such, it can be directly added to other beverages, including water, sodas, sports drinks, or other non-dairy beverages, as a natural protein supplement. As noted above, this protein fortification can occur at the same facility or at other remote beverage or food processing facilities.

The desired level of protein fortification can vary according to preference, but in accordance with a preferred embodiment an amount of the second permeate is added to a beverage such that it comprises approximately 1 to 3 percent of the beverage by volume. Alternatively, by weight, an amount of the second permeate is added so that a 16 ounce beverage serving contains approximately 5 to 15 grams of serum protein.

Initially, dairy cows 10 at any location provide milk that is transported via tank trucks 12 to receiving bays 14 at one end of the facility. Any number of trucks and receiving bays may be incorporated for this purpose. Likewise, depending on the location of the dairy farm, the milk may be delivered to the facility from the milking station via pipes or similar means. The composition of the milk as it is processed in the facility of FIG. 4 is shown in FIGS. 5A-C. The milk at the time it is received and stored within the silos is indicated in FIG. 5A at block 300, listing exemplary relative concentrations of fat, protein, lactose, and minerals. It should be understood that the values in block A may vary depending on a variety of factors related to the raising of cattle and the production of milk at the dairy.

Once at the facility, the trucks 14 unload the milk into one or more receiving silos 16. Any number of silos may be used, depending on the size of the facility and the quantity of milk processed. Likewise, while silos are used in the preferred embodiment, smaller tanks or other milk receiving or holding devices may also be used.

The milk within the silos 16 is conveyed via pipes 18 to a pasteurizer 20, which pasteurizes the raw milk. In a preferred form, a standard heating process is used for pasteurization. Any other method of pasteurization may be used, consistent with the invention. For that matter, the pasteurization step is not essential, but may be a desired or required step in standard dairy product processing. As yet another alternative, the milk may be pasteurized at the dairy farm or another location prior to delivery to the facility and receipt within the silos 16. Following pasteurization, the milk will still contain the relative concentrations indicated in block 300.

Following pasteurization, the milk is delivered, through additional pipes 18 to a cream separator 22 where the cream is removed from the whole milk, with the remaining dairy product homogenized (optionally) after the separation. It should be noted that, although not shown in most cases in FIG. 4, any number of pumps and valves are incorporated within the system as necessary to control the flow of milk from one processing station to another. In the preferred form, the cream separator comprises a centrifuge.

One of the key aspects of the preferred form of the invention is the separation of cream at a very high level. Preferably, the fat content of the separated cream will exceed 42 percent, and ideally it will be at a level of 44 percent or more, as indicated in block 302 in FIG. 5. The separation of cream at such a high concentration of fat provides for cream that is particularly well-suited for use in premium ice creams, and also produces a remaining dairy product having unique qualities. The cream is then packaged, pumped into a tank for delivery to another location, or placed in a storage tank for subsequent use in making ice cream or other products within the same facility. The remaining processing steps depicted in FIG. 4 relate to the processing of the portion of the whole milk that remains after the cream has been separated.

The product remaining after typical separation of cream from whole milk is classified as skim milk. In the preferred form as depicted in FIG. 5A, however, the amount of cream that has been removed from the milk exceeds the amount that is removed even to produce skim milk (according to known standards of identity for skim milk). Accordingly, the remaining dairy product after separation does not qualify as skim milk, is not marketable as such, and might well be discarded because it has no readily appreciated uses. The composition of the remaining product is indicated at block 304. As shown, the preferred fat concentration is a very low 0.05 percent while the protein concentration remains high.

The remaining milk product is then passed through a microfiltration membrane 24, which produces a first permeate 28 and a first retentate 26. The microfiltration membrane 24 reduces the amount of bacteria that has formed, thereby not requiring excessive heating during UHT pasteurization. The permeate following microfiltration has a preferred composition as indicated in block 306, while the retentate has a preferred composition as indicated in block 308. The retentate is high in protein and casein while relatively low in concentration of fat and other components. The permeate, however, is also relatively high in total protein and lactose concentration while containing virtually no fat.

The permeate 28 is then passed through an ultrafiltration membrane 30, which produces a second permeate 32 and a second retentate 34. The second permeate 32 is comprised primarily of water and lactose, as indicated in block 310. For that reason, a portion of the permeate purified using reverse osmosis or diafiltration, then fed back via pipes 36 and reused to aid in the microfiltration process at block 24. The remaining permeate 32 is transferred to a wastewater pretreatment block 38, where reverse osmosis, addition of enzymes, or other processes are used to remove lactose and much of the remaining other compounds (see block 312, consisting primarily of lactose) so that the water can be disposed of properly. The lactose 312 can alternatively be dried and bagged for subsequent sale as a separate product.

The second retentate 34 (ultrafiltration) isolates the serum proteins found only in this permeate and contains virtually no fat. It is also very low in lactose and other components, as indicated in block 308. The second retentate is optionally passed to a reverse osmosis condenser 40 to further concentrate the composition, and then transferred to storage tanks or silos 42 for subsequent distribution or incorporation into other products.

Because the second retentate 34 is very high in serum protein but contains no fat and very few other compounds, it is essentially a protein-fortified water. It may therefore be readily used to add protein in a liquid form to other beverages (for example, sodas or sport drinks) or other food products. As shown in FIG. 4, the second retentate is preferably housed for shipment to other beverage or food processing facilities where it is incorporated into such products. Alternatively, the same facility may include additional food or beverage processing systems, drawing directly from the tanks or silos 42 to use the second retentate in any amount as desired.

Once at the facility, the trucks 14 unload the milk into one or more receiving silos 16. Any number of silos may be used, depending on the size of the facility and the quantity of milk processed. Likewise, while silos are used in the preferred embodiment, smaller tanks or other milk receiving or holding devices may also be used.

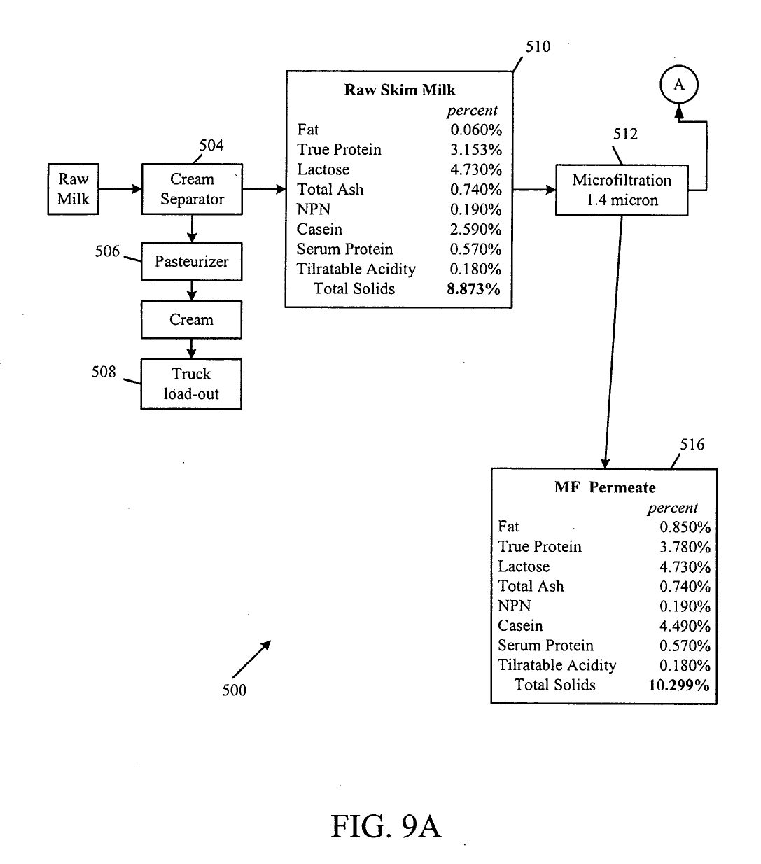

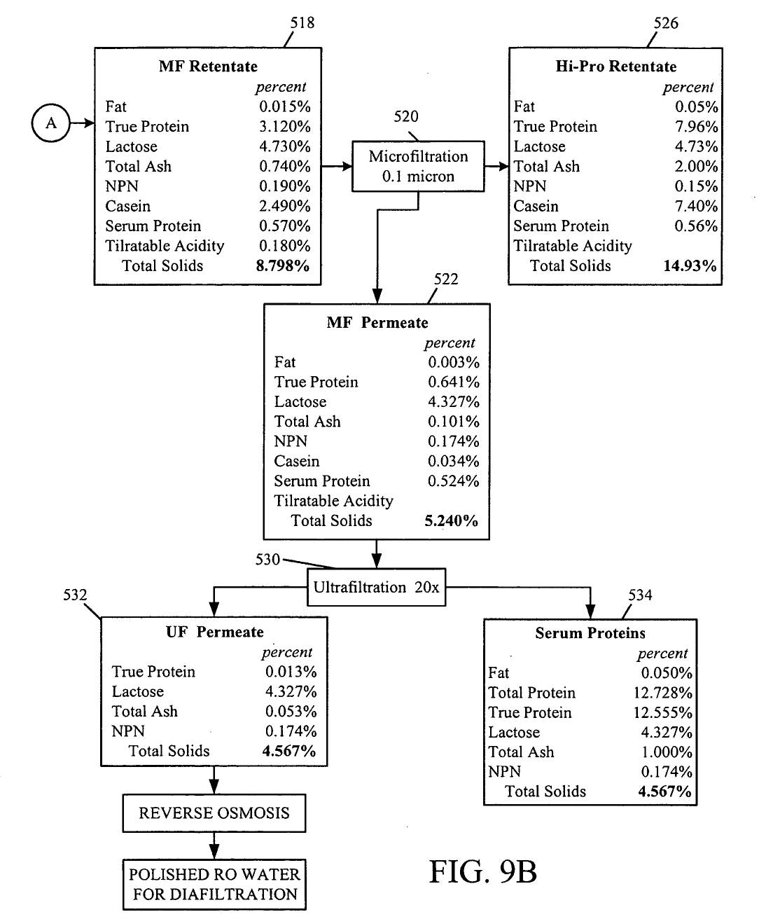

As shown in FIGS. 9A and B, an alternative process 500 is shown. Raw milk is delivered to a separator where cream is removed from the whole milk (block 504). In the preferred form, the cream separator includes a centrifuge.

At a block 506, the removed cream is pasteurized. In a preferred form, a standard heating process is used for pasteurization. Any other method of pasteurization may be used, consistent with the invention. For that matter, the pasteurization step is not essential, but may be a desired or required step in standard dairy product processing.

The fat content of the separated cream will exceed 42 percent, and ideally it will be at a level of 44 percent or more. The separation of cream at such a high concentration of fat provides for cream that is particularly well-suited for use in premium ice creams, and also produces a remaining dairy product having unique qualities. At a block 508, the cream is then packaged, pumped into a tank for delivery to another location, or placed in a storage tank for subsequent use in making ice cream or other products within the same facility.

The product remaining after typical separation of cream from whole milk is classified as skim milk. However, the amount of cream that has been removed from the milk exceeds the amount that is removed even to produce skim milk (according to known standards of identity for skim milk). Accordingly, the remaining dairy product after separation does not qualify as skim milk, is not marketable as such, and might well be discarded because it has no readily appreciated uses. The composition of the remaining product is indicated at block 510. As shown, the preferred fat concentration is a very low 0.06 percent while the protein concentration remains high.

At a block 512, the remaining milk product is then passed through a microfiltration membrane of which produces a first permeate (block 516) and a first retentate (block 518). In one embodiment, the microfiltration membrane (block 512) filters out particles with diameters greater than approximately 1.4μ. The retentate is high in protein and casein while relatively low in concentration of fat and other components. The permeate, however, is also relatively high in total protein and lactose concentration while containing virtually no fat. The microfiltration membrane reduces the amount of bacteria that has formed, thereby not requiring excessive heating during UHT pasteurization.

The permeate is then passed through a second microfiltration membrane (block 520) that filters out particles with diameters greater than approximately 0.1μ. This produces a second permeate (block 522) and a high protein (Hi-Pro) retentate (block 526). The second permeate is sent through an ultrafiltration member (block 530), which produces a third permeate that is comprised primarily of water and lactose (block 532). For that reason, a portion of the permeate is purified using reverse osmosis or diafiltration, then fed back via pipes and reused to aid in the microfiltration process at block 512. The remaining permeate is transferred to a wastewater pretreatment, where reverse osmosis, addition of enzymes, or other processes are used to remove lactose and much of the remaining other compounds so that the water can be disposed of properly. The lactose can alternatively be dried and bagged for subsequent sale as a separate product.

The retentate (block 534) after ultrafiltration (block 530) includes the serum proteins found only in the permeate (block 522) and contains virtually no fat. It is also very low in lactose and other components. The retentate (block 534) is optionally passed to a reverse osmosis condenser to further concentrate the composition, and then transferred to storage tanks or silos for subsequent distribution or incorporation into other products.

Because the retentate (block 534) is very high in serum protein but contains no fat and very few other compounds, it is essentially a protein-fortified water. It may therefore be readily used to add protein in a liquid form to other beverages (for example, sodas or sport drinks) or other food products.

Because of the two microfiltration steps, the High-Pro retentate does not require pasteurization due to a very low bacteria count. Therefore, the expensive step of pasteurization can be avoided.

In some embodiments, the invention results in a milk product with an amino acid profile, a ratio of casein protein to MSP and a concentration of the proteins, individually and in combination, that is different from that of native milk and other forms of milk protein concentrate (MPC). It thus overcomes many of the flavor, regulatory, labeling and consumer acceptability issues that exist with the art as hitherto practiced.

The membrane preferred in this invention may be a microfiltration membrane that retains the caseins in milk that may include those in the form of colloidal microparticles of 20 to 200 nanometers in size. In some embodiments, the membrane may allow smaller components in milk to pass through, such as, the milk soluble proteins, soluble salts of potassium, sodium, calcium, and the like, and carbohydrates such as lactose. This may enable producing a milk product depleted of certain components of milk and enriched with other components. Microfiltration membranes are typically classified in terms of their pore size Membranes with nominal manufacture classified pore sizes of 0.05 microns to 0.5 microns have been shown to be suitable for use in the present invention. Improved sensory properties have been found in non-fat milk concentrated about two to eight times, and preferably three times, according to one embodiment of the inventive method disclosed herein. Or, in other words, removal of about 50 to 88% of the original volume of the milk as permeate. In one embodiment, the original milk is reduced by 60-70% in volume. In such an embodiment, the MSP fraction of proteins may also be reduced by 60-70% compared to the original nonfat milk.

Soluble components of milk, in addition to MSP, such as monovalent mineral salts, lactose, and nonprotein nitrogen may also be reduced in the same proportion as the MSP. However, experiments conducted by the inventor have shown that a substantial portion of the calcium in milk, which is typically in the form of colloidal calcium phosphate, is also retained by the membrane. Inclusion of the native calcium in the retentate helps to maintain the native structure of the casein micelle. Experiments conduced by the inventor have shown that superior sensory attributes may be obtained where the native structure of the casein micelle is preserved. The inventor has likewise discovered that Maintaining the pH of the milk close to the normal pH of milk during processing promotes retention of calcium.

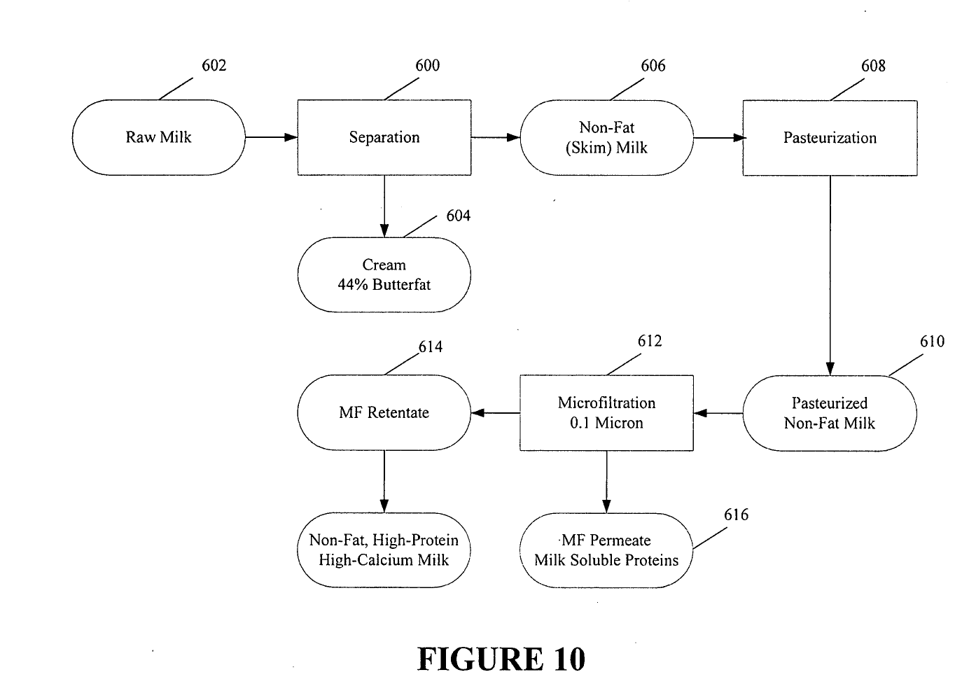

Referring to FIG. 10, one method for producing a non-fat high-protein milk may include separating 600 Raw milk 602 into cream 604 and non-fat milk 606. The separating 600 may be accomplished by centrifugation as known to those skilled in the art, such that the cream 604 obtained is about 40 to 50 percent fat. In one embodiment the cream 604 is about 43 to 45% fat. The low fat milk 606 may be less than 0.5% fat. In one embodiment, the non-fat milk 606 is less than 0.1% fat. The non-fat milk 606 milk may be pasteurized 608. The pasteurization step may be performed to meet legal and safety requirements. The pasteurized milk 610 may then be subjected to a microfiltration step 612, which may produce a concentrated retentate 614. The retentate 614 may contain substantially all of the casein protein and a substantial portion of the calcium of the non-fat milk 606. The retentate 614 may contain a reduced amount of the MSP and lactose of the non-fat milk 606. The retentate 614 may be further processed for formulation as a beverage, and/or packaged for sale. For example, it may be advantageous to dilute the retentate 614 with water, a milk ultrafiltrate as described below, a simulated milk ultrafiltrate, or other liquid to obtain the desired protein content per serving.

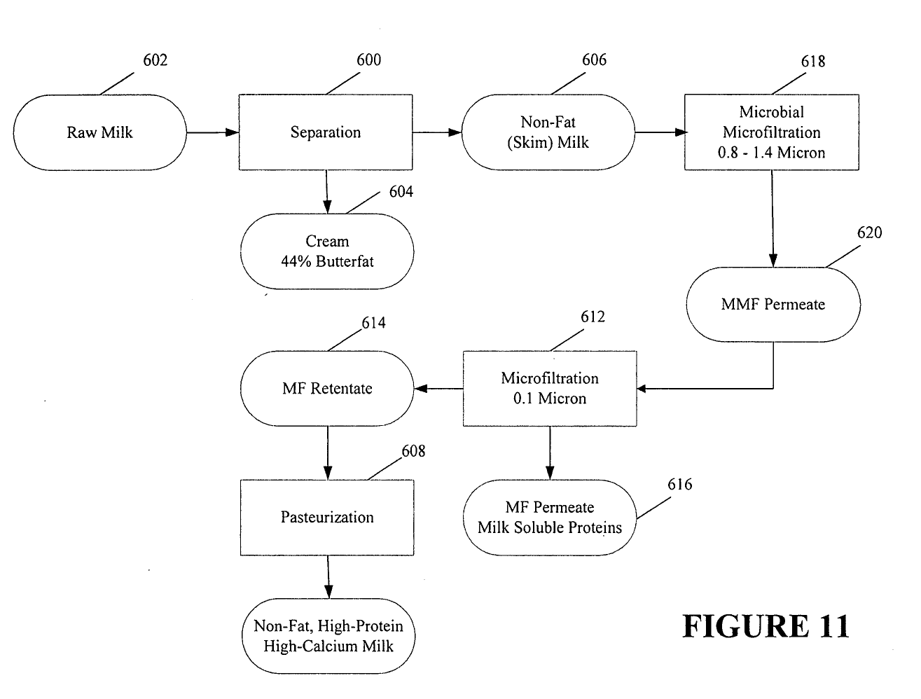

Referring to FIG. 11, in another embodiment, the raw milk 602 is microfiltered 618 through a relatively large-pore MF membrane hereinafter referred to as microbial microfiltration (MMF) step 618. The MMF membrane may contain pores of the size of about 0.8 microns to 1.4 microns. The MMF step 618 may reduce the microbial load, i.e., the number of bacteria and other microorganisms in the nonfat milk 606. This MMF step 618 is known in the art and commercially practiced under the trade name of BACTOCATCH. The permeate 620 from the MMF contains substantially all components other than microorganisms and fat in approximately the same concentrations as the non-fat milk 606. The permeate 620 is processed via the main microfiltration step 612 as described in conjunction with FIG. 10. The retentate 614 of the microfiltration step 612 may then undergo the pasteurization step 608.

The retentate 614 may contain higher casein protein and calcium concentrations as compared to the non-fat milk 606. However, although the MSP, lactose and other soluble permeable microcomponents of the non-fat milk 606 pass through the membrane into the permeate 616, their concentration in the retentate 614 may not be significantly lower than the starting non-fat milk 606 due to the equilibrium partitioning nature of such a membrane filtering processes. However, the concentration of permeable compounds, such as lactose, may be lower per unit of casein and per unit of calcium.

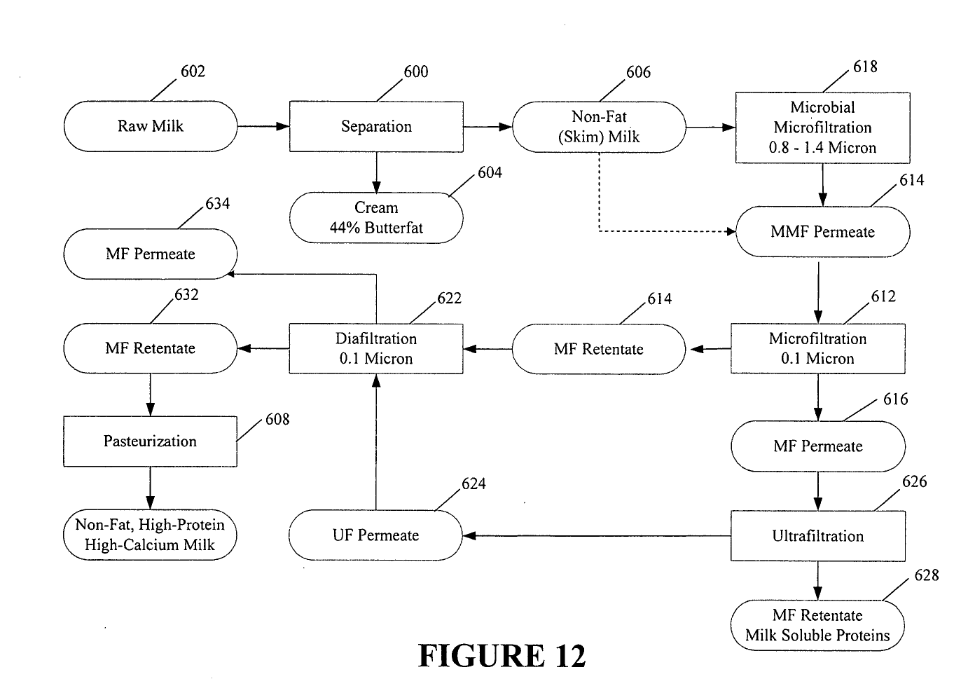

Referring to FIG. 12, in an alternative embodiment, diafiltration is used to process the non-fat milk 606. Diafiltration may be useful to reduce the concentrations of permeable soluble compounds, such as MSP and lactose, in the retentate 614. Direct concentration through filtration may be less effective to remove such soluble compounds. For example, a reduction of 99 percent of MSP through direct concentration may result in membrane fouling and low membrane flux. Diafiltration, in which additional permeable fluid is added to the non-fat milk 606 upstream of a microfilter, may be used to overcome this problem. However, experiments conducted by the inventor have shown that using water as a diafiltration fluid commonly results in a beverage with poor flavor. The inventor's experiments have shown that water and other liquids that do not contain substantial amounts of some milk micro-components, such as the milk salts, may cause some of the salts, calcium, and other compounds in the retentate 614 to diffuse out with the MSP. Maintaining the pH of the diafiltration fluid within certain levels may improve the quality of diafiltered retentate 614. Decreasing calcium within the retentate may change the size of the casein micelle as a result of the weakening and loosening of calcium bridges and bonds that maintain the micelle structure. Experiments conducted by the inventor have shown that alteration of the casein micelle is one cause of degradation of the sensory and textural attributes of some milk products.

In one embodiment of the invention, a diafiltration fluid including milk ultrafiltrate is used to avoid degradation of the casein micelle. A diafiltration step 622 may include combining the retentate 614 from the microfiltration step 612 with a permeate 624 from an ultrafiltration 626 of the permeate 616 of the micro filtration step 612. The retentate 614 from the microfiltering step 612 is typically high in protein and calcium.

The permeate 616 from the microfiltration step 612 may be ultrafiltered 626 using membranes designed to retain MSP. Such membranes come in a variety of materials, pore sizes and configurations as described by, for example, Cheryan (1998). By subjecting the MF permeate 616 to ultrafiltration 626, the MSP is separated from the micro-components of the MF permeate. Lowering the MSP content tends to improve the flavor of the final product. Accordingly, the UF retentate stream 628 contains essentially all or most of the MSP. The UF permeate stream 624 typically contains primarily milk salts and other micro-components. The UF permeate 624 may be used as the diafiltration fluid in the diafiltration step 622.

Diafiltration step 622 may be used to wash away additional MSP from the high-protein high-calcium nonfat milk 606. By diafiltering 622 against the milk salts contained in the UF permeate, it is possible to prevent or minimize the loss of lactose and salts, especially calcium phosphate, from the MF retentate stream 632, thus retaining the sensory and textural attributes and the visual appeal in the retentate stream 632. Diafiltration 622 may be continued until the desired degree of removal or reduction of MSP is obtained. Retentate 632 is then processed as needed, for example by pasteurization 608 and/or appropriate packaging. Permeate 634 may be discarded, processed to extract MSP and lactose, ultrafiltered for use as a diafiltration fluid, or the like.

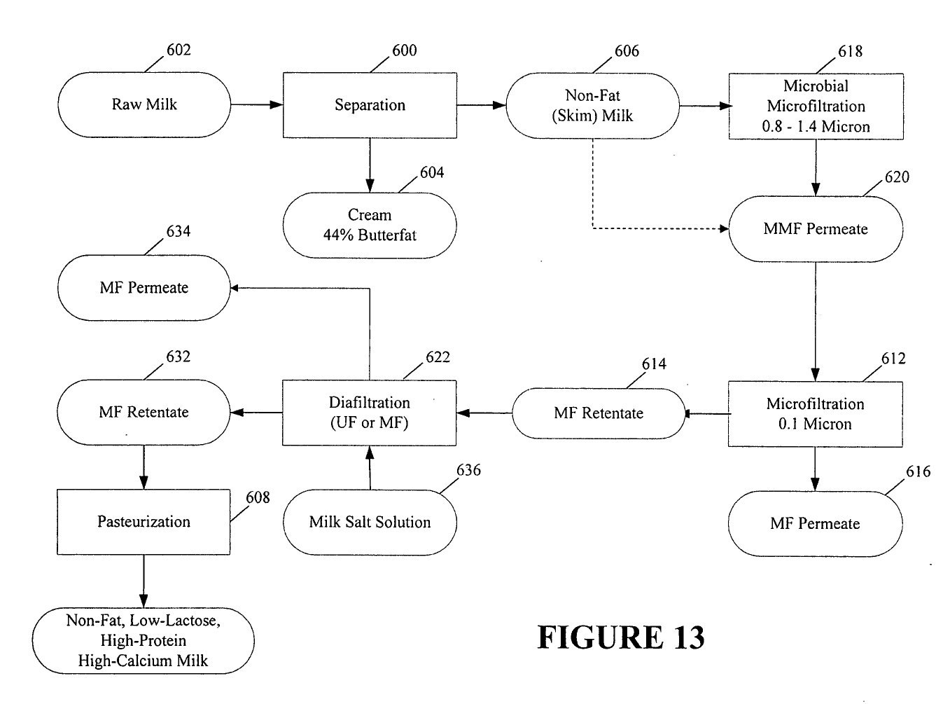

Referring to FIG. 13, in yet another embodiment a milk salt solution 636 having some attributes of a milk ultrafiltrate is used as the diafiltration fluid. The milk salt solution 636 may serve as a buffer to maintain the pH of the combined milk salt solution 636 and retentate 614. The use of a milk salt solution 636 may serve to selectively reduce the lactose content while still maintaining many of the desirable properties of a milk ultrafiltrate. The simulated milk ultrafiltrate (SMUF) formulated by Jenness and Koops (1962) is an example of a suitable milk salt solution 636. The presence of calcium phosphate and other salts normally contained in the serum phase of milk in the milk salt solution 636 reduces loss of calcium while allowing lactose to be removed. The resulting retentate 632 has the desired lactose concentration. The lactose content of the retentate 632 may be controlled by controlling the degree of diafiltration and/or concentration during diafiltration 622.

Various alternative to the diafiltration processes of FIGS. 12 and 13 are possible. For example, in one variation, diafiltration 622 is performed using the same membrane as in microfiltration step 612 in order to remove more of the MSP and lactose. In another embodiment, the microfiltration step 612 is omitted or the diafiltration step 622 is performed prior to the microfiltration step 612. In another alternative, diafiltration 622 may be performed using an ultrafiltrate membrane such that lactose is reduced while keeping the MSP concentration substantially constant in order to maintain the ratio of casein to MSP at about the same level as the retentate 614. In such embodiments, diafiltration 622 may be performed using either water or a milk salt solution 636 as described hereinabove.

### EXAMPLE 1

About 100 gallons of raw milk 602 was centrifuged to separate the cream 604 from the non-fat milk 606. The non-fat milk 606 was preheated to 50° C. and processed through a cross-flow microfiltration plant containing several ceramic membrane elements each with a pore size of 0.1 microns. The system was operated at a high cross-flow velocity in the UTP mode. The permeate 616 flow rate was maintained at 90 L/h and the retentate 614 flow rate was maintained at 45 L/hour to result in a 3× concentration factor throughout the run. Concentration factor may be defined as the volume of feed divided by the volume of retentate. The pressures were maintained approximately as follows: feed inlet of 4.4-4.5 bar, feed outlet of 2.4-2.5 bar, permeate inlet of 4.0-4.1 bar, permeate outlet of 2.2-2.3 bar; these pressures were adjusted as needed during the operation to maintain the required flows. The retentate 614 was collected, cooled and stored refrigerated in suitable containers. In some cases, the retentate 614 was dried by spray drying and/or by freeze drying.

Table 1 shows the analysis of the feed, product retentate 614 and permeate 616 of a typical milk product as described in this example. The insoluble and other components larger than the pore size of the membrane (e.g., caseins and fat) have been concentrated in the MF retentate 614. In addition, the calcium, which is bound or otherwise associated with the casein micelle, is also concentrated, though not to the same degree as the casein and fat. This is because about 15-20% of the calcium in normal milk is in the soluble form and will permeate the membrane. The milk soluble proteins, most of which are soluble and smaller in size than the membrane pore, also permeate through the membrane. MSP will be present in both permeate and retentate in almost the same concentration as the feed.

TABLE 1
Analysis of milk products by 3× microfiltration
with 0.1-micron membrane

| COMPONENT | FEED MILK | MF RETENTATE | MF PERMEATE |
|---|---|---|---|
| Total solids | 8.80 | 14.1 | 5.6 |
| Fat | 0.07 | 0.21 | ˜0 |
| Total protein | 3.25 | 8.2 | 0.77 |
| (N × 6.38) | | | |
| Protein (dry | 36.9 | 58.2 | 13.8 |
| basis) | | | |
| Casein | 2.48 | 7.41 | ˜0 |
| Milk soluble | 0.72 | 0.80 | 0.72 |
| protein | | | |
| Lactose | 4.7 | 4.7 | 4.7 |
| Ash | 0.71 | 1.2 | 0.11 |
| Calcium | 0.12 | 0.30 | 0.02 |

It is to be noted that it may be advantageous to retain the desirable components in the retentate 614 and pass certain compounds into the permeate 616, such as the milk soluble proteins and lactose and soluble salts. This may be accomplished with a ceramic membrane of the appropriate porosity which is configured and operated in a suitable manner, such as, for example, with high cross-flow velocities, low transmembrane pressures and uniform pressure drop down the axial length of the membrane in the direction of permeate and retentate flow in such a manner as to maintain a uniform transmembrane pressure down the entire length of the membrane element. Although polymeric membranes in the spiral wound or other configuration may also be used, such membranes and configurations have been found to result in more rapid fouling, unsustainable steady-state operation, and unacceptable changes in the compositional profile during processing so as to render the resulting products less appealing. Table 2 shows the amino acid composition of milk and the products from the microfiltration of skim milk to about three times the protein content of non-fat milk.

TABLE 2
Amino acid profiles of milk, high-protein milk product
(MF retentate) and the MF permeate from the 0.1-micron
membrane at a 3× concentration factor. Data expressed
as grams amino acid per 100 grams protein

| AMINO | MILK (USDA | MF | MF |
|---|---|---|---|
| ACID | Handbook No. 8) | RETENTATE | PERMEATE |
| Alanine | 3.43 | 3.12 | 4.84 |
| Arginine | 3.61 | 3.56 | 2.81 |
| Aspartic acid | 7.60 | 7.35 | 11.61 |
| Cystine | 0.91 | 0.57 | |
| Glutamic acid | 21.42 | 23.49 | 19.96 |
| Glycine | 2.13 | 1.84 | 1.81 |
| Histidine | 2.70 | 2.60 | 2.02 |
| Isoleucine | 5.97 | 4.81 | 5.52 |
| Leucine | 9.74 | 9.65 | 12.58 |
| Lysine | 8.02 | 7.91 | 10.05 |
| Methionine | 2.56 | 2.75 | 2.26 |
| Phenylalanine | 4.87 | 4.91 | 3.68 |
| Proline | 9.70 | 10.25 | 6.17 |
| Serine | 5.27 | 5.58 | 4.58 |
| Threonine | 4.56 | 4.17 | 5.00 |
| Tryptophan | 1.40 | 1.14 | 1.83 |
| Tyrosine | 4.83 | 5.29 | 3.70 |
| Valine | 6.64 | 6.61 | 5.38 |

### EXAMPLE 2

The products of this invention may contain less lactose per unit of calcium or protein. Regular skim milk has a lactose-to-calcium ratio of 39, while the 3× microfiltered milk shown in Table 1 has a lactose/calcium ratio of 16. To produce a reduced-lactose product, then the retentate may be subjected to diafiltration as illustrated in FIGS. 12 and 13. Table 3 shows the effect of adding water or a simulated milk ultrafiltrate (SMUF), as defined and formulated by Jenness and Koops (1962), as a diafiltration fluid as defined and formulated by Jenness and Koops (1962) to the 3× retentate 614 of Table 1. In this example, diafiltration liquid is added at a rate equal to the rate of removal of permeate 634 and is expressed as the percentage of the starting volume of milk 606. As shown in Table 3, diafiltration 622 results in a slight reduction in protein, due to removal of the remaining MSP in the MF retentate, and a large reduction in lactose content depending on the degree of diafiltration.

TABLE 3
Effect of diafiltration of milk retentate
with MF membrane on lactose and protein

| % VOLUME OF | | | |
|---|---|---|---|
| WATER OR | TOTAL PROTEIN | LACTOSE | % REDUCTION |
| SMUF ADDED | (% W/W) | (% W/W) | OF LACTOSE |
| 0 | 8.2 5.0 | 5.0 | 0 |
| 50 | 7.9 3.1 | 3.1 | 38 |
| 73 | 7.8 2.5 | 2.5 | 50 |
| 100 | 7.7 1.8 | 1.8 | 63 |
| 200 | 7.5 0.7 | 0.7 | 85 |
| 300 | 7.5 0.3 | 0.3 | 94 |

For example, if a milk product with 50% lower lactose is required, the milk may be first microfiltered 612 to a concentration factor of three as shown in Table 1, and then the retentate 614 may be diafiltered 622 with water or SMUF equivalent to about 73% of the volume of the starting retentate 614. A retentate 632 that is 85% reduced in lactose may be produced using as much diafiltration solution as the original volume of the retentate 614 and result in a lactose/calcium ratio of less than three, which is highly desirable for those suffering from lactose intolerance.

Although this example describes diafiltration 622 following concentration, it is understood that the reverse could be done, i.e., diafiltration 622 before concentration, or any combination thereof. This may depend to a large extent on the performance of the selected membrane and other operating conditions.

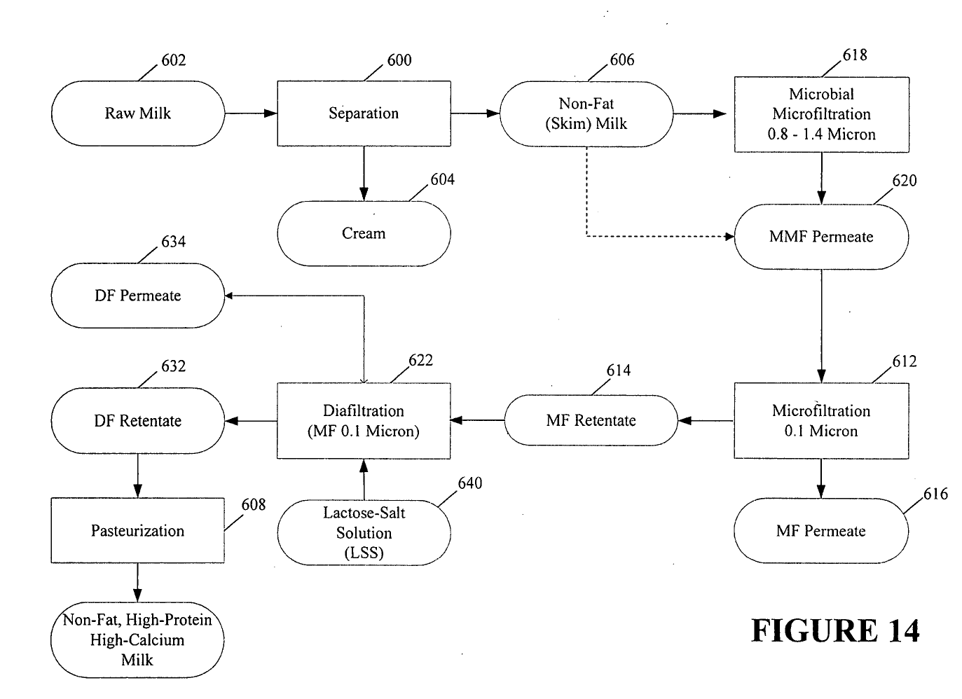

Referring to FIG. 14, in yet another embodiment, removal of MSP may be enhanced without substantially changing the concentration of lactose and/or milk salts within the retentate 632. In the embodiment of FIG. 14, a lactose-salt solution (LSS) 640 is used in the diafiltration step 622. The lactose-salt solution 640 may contain the same concentrations of lactose and milk salts as the UF permeate 624 or the permeate stream 616. The LSS 640 may be made using lactose and milk salts purchased from commercial sources or from a commercial UF permeate powder obtained by the ultrafiltration or microfiltration of whey or milk, or similar products.

Diafiltration with the LSS may reduce the loss of lactose and salts from the MF retentate stream 632, thus improving retention of the sensory properties, textural attributes and visual appeal of the retentate stream 632. Diafiltration 622 may be continued, such as by adding additional LSS 616, until the desired degree of removal or reduction of MSP is obtained. Retentate 632 may then be processed as needed, for example by pasteurization 618, homogenization, and/or packaging.

While the preferred embodiment of the invention has been illustrated and described, as noted above, many changes can be made without departing from the spirit and scope of the invention. Accordingly, the scope of the invention is not limited by the disclosure of the preferred embodiment.

What is claimed is:

1. A method for making a composition obtained from milk, comprising:
providing a milk product stream;
introducing a diafiltration fluid stream containing substantial amounts of milk micro components into the milk product stream; and
executing a concentrating microfiltering step on the milk product stream to produce a first permeate stream and a first retentate stream.

2. The method of claim 1, wherein the micro components comprise milk salts in concentrations approximating that of milk ultrafiltrate.

3. The method of claim 2, further comprising ultrafiltering the first permeate stream to produce a second permeate stream and a second retentate stream, the diafiltration fluid comprising a portion of the second permeate stream.

4. The method of claim 2, wherein the diafiltration fluid is simulated milk ultrafiltrate.

5. The method of claim 1, wherein the diafiltration fluid has a pH substantially equal that of milk ultrafiltrate.

6. The method of claim 1, wherein the diafiltration fluid comprises calcium salts.

7. The method of claim 6, wherein the calcium salts comprise calcium phosphate

8. The method of claim 1, wherein the first retentate stream has a protein concentration of between about 2 to 6 times that of the milk product stream.

9. The method of claim 1, further comprising executing a purifying microfiltration step on the milk product stream prior to the concentrating microfiltration step.

10. The method of claim 9, wherein the purifying microfiltration step comprises filtering the milk through a microfilter having a pore size of about 0.8 to 1.4 microns.

11. The method of claim 1, wherein executing the concentrating microfiltration step comprises filtering the milk through a microfilter having a pore size of about 0.05 to 0.5 microns.

12. The method of claim 1, wherein executing the concentration microfilteration step comprises filtering the milk through a microfilter having a pore size of about 0.1 micron.

13. The method of claim 1, further comprising a skimming step comprising removing cream from the milk.

14. The method of claim 13, wherein the skimming step comprises removing cream from the milk product stream, the cream having a fat content of about 40 to 50 percent.

15. The method of claim 14, wherein the skimming step comprises removing cream from the milk product stream, the cream having a fat content of about 43 to 45 percent.

16. The method of claim 13, wherein the skimming step reduces fat content of the milk stream to less than about 0.5%.

17. The method of claim 16, wherein the skimming step reduces fat content of the milk to less than about 0.1%.

18. The method of claim 1, wherein the diafiltration fluid stream is introduced at a volume rate greater than 50 percent of a volume rate of the milk stream.

19. The method of claim 18, wherein the diafiltration fluid stream is introduced at a volume rate greater than 300 percent of the volume rate of the milk stream.

20. The method of claim 1, wherein the milk product stream comprises a series of discrete batches of milk.

21. A method for making a composition made from milk, the method comprising:
providing a milk stream;
executing a first concentrating microfiltering step on the milk stream to produce a first permeate stream and a first retentate;
executing a second concentrating microfiltering step on the first retentate stream to produce a second permeate stream and a second retentate stream;
ultrafiltering the first permeate to produce a third permeate stream and a third retentate stream;
recirculating a portion of the third permeate stream into at least one of the first retentate stream and the milk stream.

22. The method of claim 21, wherein executing a second concentrating microfiltering step comprises passing the milk stream over a microfilter having a pore size of about 0.5 to 0.1 microns.

23. The method of claim 22, wherein executing a second concentrating microfiltering step comprises passing the milk stream over a microfilter having a pore size of about 0.1 microns.

24. The method of claim 21, further comprising executing a purifying microfiltering step on the milk stream.

25. The method of claim 24, wherein the purifying microfiltering step comprises passing the milk stream through a microfilter having a pore size of about 0.8 to 1.4 micron.

26. The method of claim 21, wherein the second retentate stream has a protein concentration two to six times that of the milk stream.

27. The method of claim 26, wherein the protein of the second retentate streams includes, in proportion to total protein about 3 percent Alanine, 3.5 percent Arginine, 7 percent Aspartic acid, 0.5 percent Cystine, 23.5 percent glutamic acid, 2 percent Glycine, 2.5 percent histidine, 5 percent isoleucine, 10 percent leucine, 8 percent lysine, 3 percent methionine, 5 percent phenylalanine, 10 percent praline, 5.5 percent serine, 4 percent threonine, 1 percent tryptophan, 5 percent tyrosine, and 6.5 percent valine

28. The method of claim 26, wherein the protein of the second retentate streams includes, in proportion to total protein 3.12 percent Alanine, 3.56 percent Arginine, 7.35 percent Aspartic acid, 0.57 Cystine, 23.49 percent glutamic acid, 1.84 percent Glycine, 2.60 percent histidine, 4.81 percent isoleucine, 9.65 percent leucine, 7.91 percent lysine, 2.75 percent methionine, 4.91 percent phenylalanine, 10.25 percent praline, 5.58 percent serine, 4.17 percent threonine, 1.14 percent tryptophan, 5.29 percent tyrosine, and 6.61 percent valine
